(19) United States
(12) Patent Application Publication
(10) Pub. No.: US 2024/0169260 A1
(43) Pub. Date: May 23, 2024

(54) REDUCING COMPUTATIONAL OVERHEAD ASSOCIATED WITH EXECUTING EXPLANATORY MODELS BY REUSING TUNING BYPRODUCTS

(71) Applicant: RED HAT, INC., Raleigh, NC (US)

(72) Inventors: Robert Joao Geada, Newcastle upon Tyne (GB); Rui Miguel Cardoso De Freitas Machado Vieira, Newcastle upon Tyne (GB)

(21) Appl. No.: 18/080,265

(22) Filed: Dec. 13, 2022

Related U.S. Application Data
(60) Provisional application No. 63/427,042, filed on Nov. 21, 2022.

(51) Int. Cl. G06N 20/00

(52) U.S. Cl. CPC G06N 20/00

(57) ABSTRACT

In some examples, a system can obtain tuning data for a tuning process for configuring a first type of explanatory model to provide a first type of explanatory information associated with a target model. The tuning data can include a mapping of inputs to, and outputs from, the target model. The system can store the tuning data for subsequent use. Thereafter, the system can receive a request for a second type of explanatory information associated with the target model. The request can indicate a target output from the target model. The system can determine whether any outputs in the mapping match the target output. If so, the system can provide the corresponding inputs from the mapping as the second type of explanatory information, for example without having to execute a second type of explanatory model to generate the second type of explanatory information, thereby conserving computing resources.

### CROSS-REFERENCE TO RELATED APPLICATION

This application claims the benefit of priority under 35 U.S.C. § 119(e) to U.S. Provisional Patent Application No. 63/427,042, filed on Nov. 21, 2022, the entirety of which is hereby incorporated by reference herein.

### TECHNICAL FIELD

The present disclosure relates generally to explanatory models usable to explain the functionality of machine-learning models. More specifically, but not by way of limitation, this disclosure relates to reducing computational overhead associated with executing explanatory models by reusing tuning byproducts.

### BACKGROUND

The field of explainable artificial intelligence (XAI) seeks to investigate the intuition of black-box models, which are prediction systems whose inner workings are either inaccessible or so complex as to be conventionally uninterpretable. Some common examples of such black-box models include deep neural networks and random forests. Explanations of these models may be necessary for regulatory reasons. For example, the General Data Protection Regulation (GDPR) entitles subjects of automated decisions the right to ask for an explanation of the decision-making process that led to those decisions. Furthermore, the behavior of these models must be investigated to ensure that they are compliant with regulations and business ethics, for example, to guarantee that they do not base their decisions on protected attributes such as race or gender.

### BRIEF DESCRIPTION OF THE DRAWINGS

FIG. 1 is a block diagram of an example of a process for reducing computational overhead associated with executing explanatory models by reusing tuning byproducts according to some aspects of the present disclosure.

FIG. 2 is a block diagram of an example of a process for determining multiple versions of explanatory information according to some aspects of the present disclosure.

FIG. 3 is a block diagram of an example of a process for determining model outputs that match a desired output according to some aspects of the present disclosure.

FIG. 4 is a block diagram of an example of a computer system usable to implement some aspects of the present disclosure.

FIG. 5 is a flowchart of an example of a process for reducing computational overhead associated with executing explanatory models by reusing tuning byproducts according to some aspects of the present disclosure.

FIG. 6 is a flowchart of another example of a process for reducing computational overhead associated with executing explanatory models by reusing tuning byproducts according to some aspects of the present disclosure.

### DETAILED DESCRIPTION

Multiple kinds of explanatory models can be used to help explain a black-box model, such as a neural network. But tuning (e.g., training or fitting) and executing explanatory models can be very computationally intensive. For example, some explanatory models may be tuned based on tens of thousands of model evaluations, where a model evaluation refers to a single input being passed through a black-box model and the resultant output recorded. The model evaluations are usually the most expensive part of the tuning process for an explanatory model, in terms of time and computational cost, because the black-box models being explained are often complex systems like neural networks whose evaluations can take on the order of seconds. These costs can compound in situations where the system is configured to provide multiple types of explanations, such as both saliency explanations and counterfactual explanations, to a user by executing multiple types of explanatory models. While providing multiple types of explanations can more comprehensively explain the target model's behavior, which can help the user gain a better understanding the model's functionality, it can also dramatically increase computational overhead because of the large number of model evaluations associated with tuning and executing multiple explanatory models.

Some examples of the present disclosure can overcome one or more of the abovementioned problems by reusing byproduct information generated during a tuning process (e.g., a training or model-fitting process) for a first type of explanatory model to avoid execution of a second type of explanatory model, while still providing a first type of explanatory information associated with the first explanatory model and a second type of explanation associated with the second explanatory model, even though the second type of explanatory model was not executed. By avoiding execution of the second type of explanatory model, the system can conserve computing resources and reduce overhead, while still providing the benefit of both types of explanations to the user.

More specifically, a computer system can receive input data and background data. Based on the input data and the background data, the computer system can generate synthetic data samples. Each synthetic data sample can be a permutation of the input data and the background data. The computer system can generate any number and combination of synthetic data samples. The computer system can then provide the synthetic data samples as input to a target model (e.g., a black-box model), which can produce outputs based on the synthetic data samples. The target model may produce one output for each synthetic data sample.

The above steps of generating the synthetic data samples, providing them as input to the target model, and recording the outputs from the target model can be part of an overall tuning process for a first type of explanatory model. The first explanatory model can be configured to produce a first type of explanatory information about the inner workings of the target model. For example, the first type of explanatory model may be a saliency model, and the synthetic data samples and resulting outputs can serve as tuning data to tune (e.g., train or fit) the saliency model. Once tuned, the saliency model can indicate how important each input variable is to outputs generated by the target model. For example, if each piece of input data includes values for five variables, the saliency model may indicate how important each of those five variables is in terms of their influence on the outputs generated by the target model.

In a conventional scenario, the tuning data and other byproducts from the tuning process may be discarded after the first type of explanatory model is tuned, for example to save memory space. For example, the synthetic data samples and corresponding outputs may be discarded. But this byproduct information can include useful explanatory data such as counterfactual information, so discarding it may be a waste of valuable knowledge. To prevent this waste, in some examples the computer system can store and reuse the byproduct information to generate the second type of explanation, rather than executing the second type of explanatory model.

As one particular example, the second type of explanatory model may be a counterfactual explainer model. A counterfactual explainer model can indicate values for a set of input variables that are needed to achieve a desired output. For example, if the desired output is that an individual qualifies for a loan, a counterfactual explainer model may indicate specific attributes (e.g., age, employment status, income, etc.) that the individual would need to have to qualify for the loan. Because the tuning data for the first type of explanatory model may include counterfactual information, in some scenarios the tuning data can be stored and reused in place of executing the counterfactual explainer model. Using this technique, relevant counterfactual explanations can be more rapidly obtained at reduced computational cost to the computer system as compared to executing the counterfactual explainer model.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

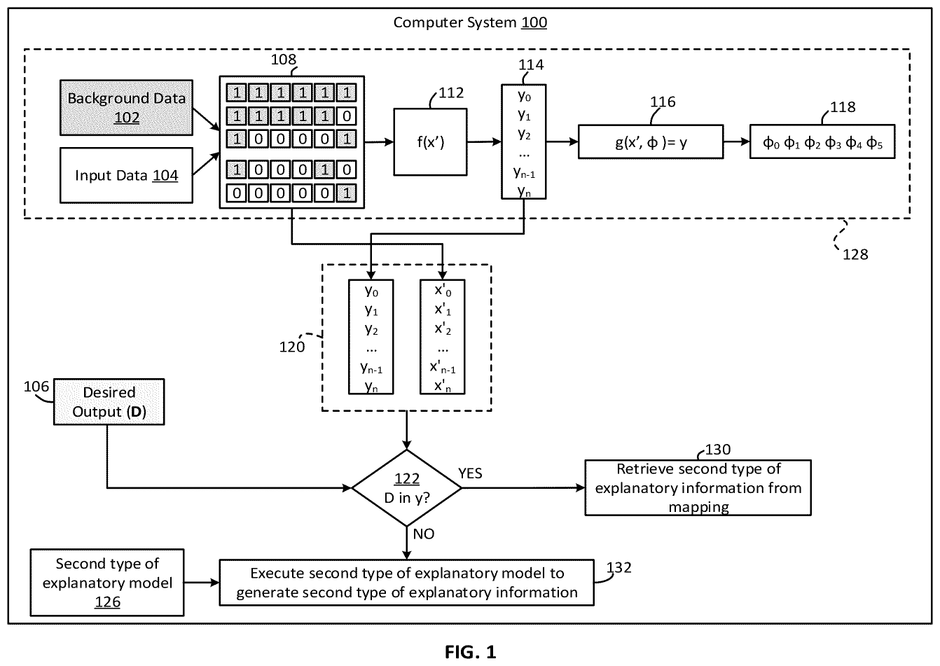

FIG. 1 is a diagram of an example of a process for reducing computational overhead associated with executing explanatory models by reusing tuning byproducts according to some aspects of the present disclosure. As shown, the process can involve a computer system 100 performing a tuning process 128 for tuning a first type of explanatory model 116. The computer system 100 can include any number and combination of computing devices, such as desktop computers, laptop computers, servers, and/or tablets.

The tuning process 128 may begin with the computer system 100 obtaining background data 102 and input data 104. The background data 102 may be pre-generated data (e.g., randomized data) that is different from the input data 104 to be evaluated. The background data 102 may be obtained from a repository, where it may be stored independently of the input data 104. The input data 104 may be provided by a user, independently of the background data 102.

The computer system 100 can next generate any number of synthetic data samples 108 based on the background data 102 and the input data 104. The synthetic data samples 108 can include various permutations of the background data 102 and the input data 104. For example, the synthetic data samples 108 can include substantially all possible permutations of the background data 102 and the input data 104. In the example shown in FIG. 1, the dark gray values in the synthetic data samples 108 are derived from the background data 102, and the white values in the synthetic data samples 108 are derived from the input data 104.

The computer system 100 can then provide the synthetic data samples 108 as input to a target model 112. Examples of the target model can include a neural network, decision tree, clusterer, classifier, factorizer, or an ensemble of models. Based on the synthetic data samples 108, the target model 112 can generate corresponding outputs 114. In this example, the outputs are represented as y₀-yₙ. Those outputs correspond to synthetic data samples x′₀-x′ₙ. The target model 112 can generate a single output (yᵢ) for each synthetic data sample (x′ᵢ).

The computer system 100 can use the outputs 114 from the target model 112 to tune a first type of explanatory model 116, such as a Shapley Additive exPlanations (SNAP) or LIME model. If the first type of explanatory model 116 is a linear regression model, the computer system 100 can use the outputs 114 to fit the weighted linear regression such that g(x′, ϕ)=y. Once tuned, the first type of explanatory model 116 can generate a first type of explanatory information 118 that may include a first set of numerical values, which are represented as ϕ₀-ϕ₅ in FIG. 1. If the first type of explanatory model 116 is a saliency model, the first type of explanatory information 118 can be any number of saliency values. Each saliency value can indicate a degree of influence that a corresponding input variable had on an output from the target model 112. For example, if the set of saliency values is {0.12, 0.23, 0.05, 0.80, 0.33, 0.45}, and each element in that list corresponds to an input variable, then the fourth input variable may have the highest degree of influence on the output from the target model 112, because the fourth input variable has the highest saliency value. Conversely, the first input variable may have the lowest degree of influence on the output from the target model 112, because the first input variable has the lowest saliency value.

In a conventional scenario, the byproducts from the tuning process, such as the input data 104 and the outputs 114, may be discarded after tuning the first type of explanatory model 116. But the byproducts can include useful explanatory information such as counterfactual information, so discarding it may be a waste of valuable knowledge. To prevent this waste, in some examples the computer system 100 can store the byproducts for subsequent use. For example, the computer system 100 may generate a mapping 120 of the synthetic data samples 108 to the outputs 114. The mapping 120 may be hashed or encoded in another manner. The computer system 100 can then store the mapping 120 in a datastore for subsequent reuse. As will be described in detail below, the computer system 100 may use such stored byproducts to generate a second type of explanation. The second type of explanation may be determined using the stored products in addition to, or as an alternative to, executing a second type of explanatory model 126.

For example, the user may wish to determine a second type of explanatory information associated with the target model 112. The second type of explanatory information can be different from the first type of explanatory information. For example, the user may wish to determine which configuration of input variables produces a desired output (D) 106 from the target model 112. The user may know the desired output 106, but may not know how to configure the input variables to achieve the desired result. For example, the user may want the desired output 106 from the target model 112 to be that an individual qualifies for a loan, but may not know which values for the input variables will produce that result. Normally, the user may execute a second type of explanatory model 126 to determine the second type of explanatory information. For example, the user may execute a counterfactual explainer model on the computer system 100 to determine a configuration of input variables that produces the desired output 106. But tuning and executing the second type of explanatory model 126 may be resource intensive. For instance, counterfactual explainer models can consume a significant amount of processing power and memory.

To overcome the abovementioned problems, in some examples the computer system 100 may first check 122 the stored byproducts (e.g., mapping 120) to determine whether they include the desired output 106 or a relatively close approximation thereto. If so, the computer system 100 can simply retrieve a corresponding set of information from the stored byproducts and present it back to the user as the second type of explanatory information. This is shown in block 130. For example, the user may input a desired output 106, such as output y₂. The computer system 100 can analyze the mapping 120, determine that output y₂ exists in the mapping 120, determine that output y₂ corresponds to synthetic data sample x′₂ in the mapping 120, and present 124 the synthetic data sample x′₂ back to the user. The synthetic data sample x′₂ may be counterfactual information indicating which input variable values result in the desired output 106. Using these techniques, the computer system 100 can provide the second type of explanatory information to the user without needing to have the second type of explanatory model 126 at all. This can conserve computing resources because the computer system 100 does not need to store, tune, or execute the second type of explanatory model 126. In other examples, the computer system 100 may have the second type of explanatory model 126, but need not execute it to generate the second type of explanatory information for the user. This can also conserve computing resources. Of course, if the computer system 100 checks 122 the stored byproducts and determines that neither the desired output 106 nor a relatively close approximation thereto is listed in the stored byproducts, the computer system 100 can execute the second type of explanatory model 126 to produce the second type of explanatory information for the user, as shown in block 132.

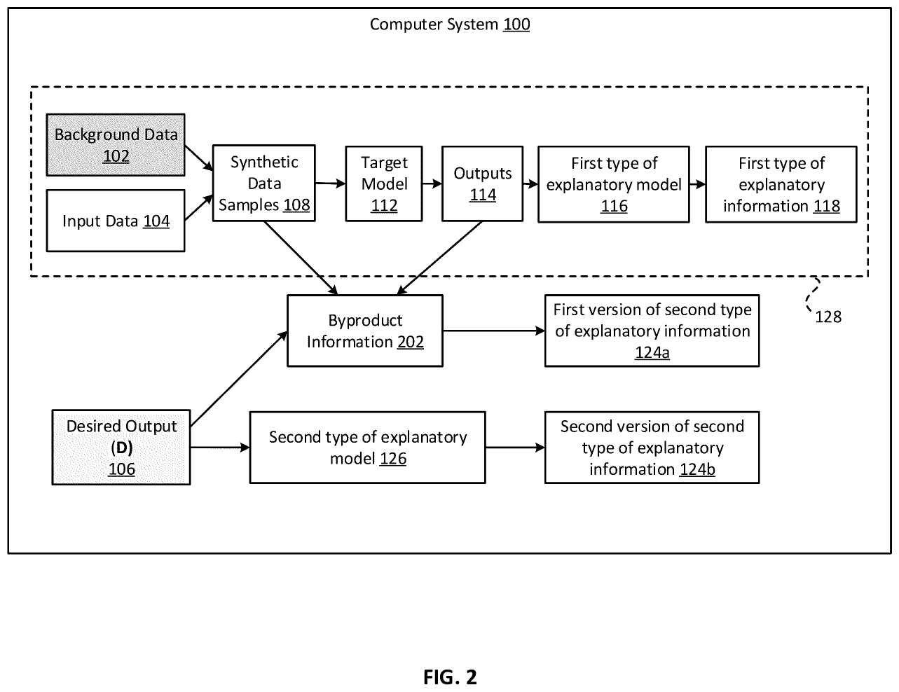

In some examples, the computer system 100 may rely on both the stored byproducts and the second type of explanatory model 126 to generate two versions of the second type of explanatory information for the user. An example of this process is shown in FIG. 2. As shown, the computer system 100 can generate the byproduct information 202 as a result of a tuning process 128 associated with a first type of explanatory model 116, such as a saliency model. The computer system 100 can then use the stored byproduct information 202 to quickly provide a first version 124a of the second type of explanatory information to the user. Since the first version 124a may be less accurate, the computer system 100 can also execute the second type of explanatory model 126 (e.g., in the background) to generate a second version 124b of the second type of explanatory information that may be more accurate than the first version 124a. Once the second version 124b is ready, the computer system 100 may also provide the second version 124b to the user. This bifurcated approach may allow the user to quickly obtain a lower-accuracy response that can be supplemented later on with a more accurate response, allowing the user to balance speed and accuracy as needed.

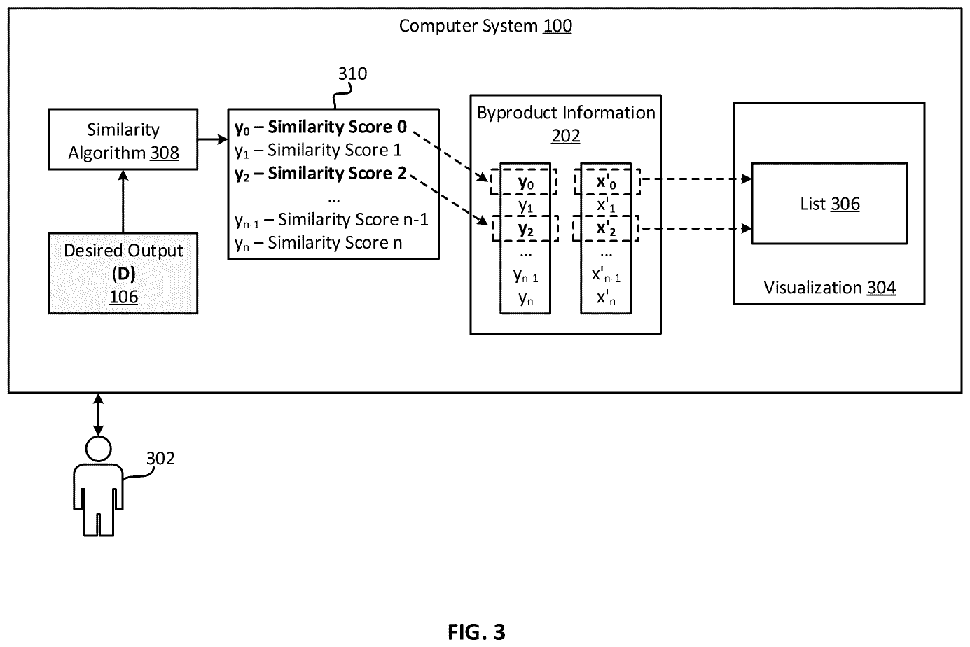

Referring now to FIG. 3, in some examples the user 302 can provide a desired output 106 to the computer system 100 for evaluation, as described above. Based on the desired output 106, the computer system 100 can compute a similarity score 310 for each model output (e.g., outputs 114) in the byproduct information 202. A similarity score 310 can represent a level of similarity between the model output and the desired output 106. The similarity scores 310 can be computed using a similarity algorithm 308. Examples of the similarity score can include a Hamming distance, a cartesian distance, a Levenshtein distance, a Jaccard index, etc. Based on the similarity scores 310, the computer system 100 can determine which model outputs match the desired output 106. A model output can “match” the desired output 106 if it is identical to the desired output 106 or if it is sufficiently similar to the desired output 106. A model output can be sufficiently similar to the desired output 106 if it has a similarity score 310 that is within a predefined range of the desired output 106. The predefined similarity range may be user customizable, so that the user 302 can tailor the results of the process as desired. Using these techniques, the computer system 100 can determine which model outputs match the desired output 106 (e.g., y₀ and y₂ as indicated in bold), identify one or more data samples that correspond to the matched model outputs (e.g., x′₀ and x′₂ as indicated in bold), and provide an indication of the identified data samples to the user 302. The computer system 100 may additionally or alternatively provide an indication of the matched model outputs to the user 302.

In some examples, the computer system 100 may provide a visualization 304 of the matched model outputs and/or the identified data samples to the user 302. For example, the computer system 100 may generate the visualization 304 that includes a list 306 of the identified data samples. And, for each data sample, the computer system 100 can also provide the related similarity score (e.g., the similarity score corresponding to the related model output) or other attribute of the data sample. In some examples, the visualization 304 may take the form of a plot or chart. For instance, the visualization 304 can include a plot that positions the data samples along an axis and their related similarity scores or other attributes along one or more other axis. These visualizations 304 may help the user 302 easily identify which data samples would yield corresponding outputs that are closest to the user's desired output 106.

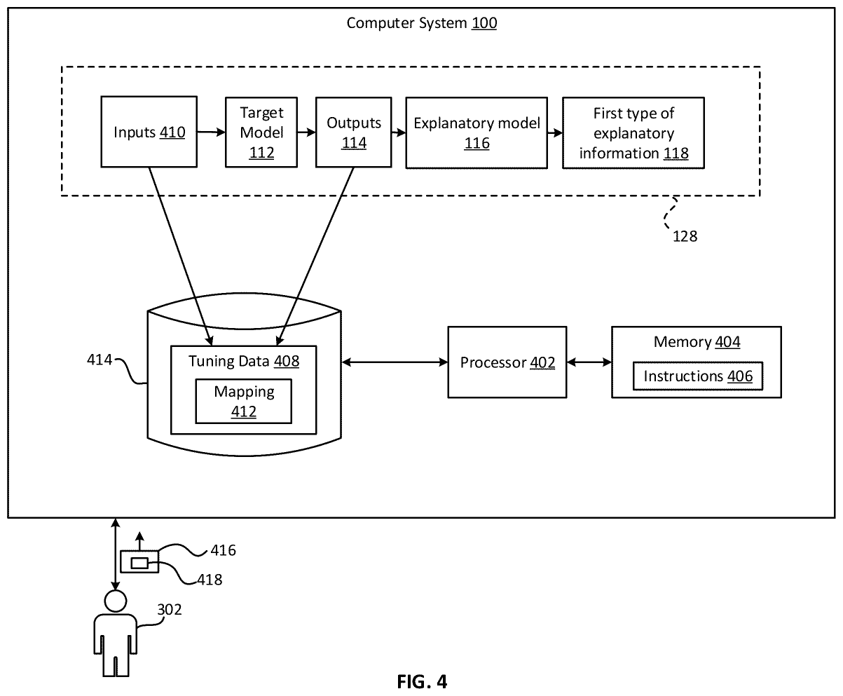

FIG. 4 is a block diagram of an example of a computer system 100 usable to implement some aspects of the present disclosure. The computer system 100 includes a processor 402 communicatively coupled to a memory 404. The processor 402 can include one processor or multiple processors. Examples of the processor 402 can include a Field-Programmable Gate Array (FPGA), an application-specific integrated circuit (ASIC), or a microprocessor. The processor 402 can execute instructions 406 stored in the memory 404 to perform operations. The instructions 406 may include processor-specific instructions generated by a compiler or an interpreter from code written in any suitable computer-programming language, such as C, C++, C#, Java, or Python.

The memory 404 can include one memory device or multiple memory devices. The memory 404 can be volatile or non-volatile (it can retain stored information when powered off). Examples of the memory 404 include electrically erasable and programmable read-only memory (EEPROM), flash memory, or cache memory. At least some of the memory 404 includes a non-transitory computer-readable medium from which the processor 402 can read instructions 406. A computer-readable medium can include electronic, optical, magnetic, or other storage devices capable of providing the processor 402 with the instructions 406 or other program code. Examples of a computer-readable mediums include magnetic disks, memory chips, ROM, random-access memory (RAM), an ASIC, a configured processor, and optical storage.

In some examples, the processor 402 can execute the instructions 406 to perform operations. For example, the processor 402 can obtain tuning data 408 used in a tuning process 128 for configuring an explanatory model 116 to provide a first type of explanatory information 118 associated with a target model 112. The tuning data 408 can include a mapping 412 of inputs 410 to the target model 112 and corresponding outputs 114 from the target model 112. The processor 402 can store the tuning data 408 in a datastore 414, such as a volatile or non-volatile memory device.

Subsequent to storing the tuning data 408 in the datastore 414, the processor 402 can receive a request 416 from a user 302 for a second type of explanatory information 124 associated with the target model 112. The request 416 can include a target output 418 from the target model 112. In response to receiving the request 416, the processor 402 can determine whether any outputs 114 in the mapping 412 match the target output 418. In response to determining that a particular output in the mapping 412 matches the target output 418, the processor 402 can determine a particular input in the mapping 412 that corresponds to the particular output. The processor 402 can then provide the particular input to the user 302 as the second type of explanatory information 124.

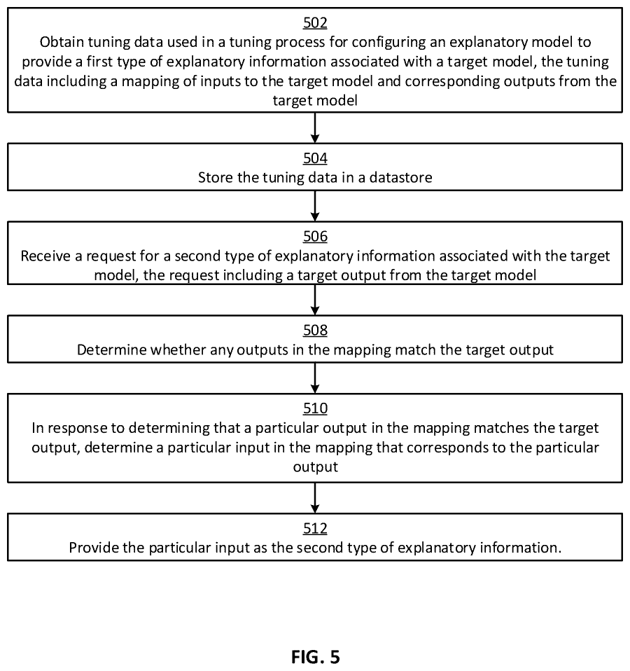

FIG. 5 is a flowchart of an example of a process for reducing computational overhead associated with executing explanatory models by reusing tuning byproducts according to some aspects of the present disclosure. Other examples may involve more operations, fewer operations, different operations, or a different order of operations than is shown in FIG. 5. The operations of FIG. 5 are described below with reference to the components of FIGS. 1-4.

In block 502, the processor 402 obtains (e.g., receives or generates) tuning data 408 used in a tuning process 128 for configuring an explanatory model 116 to provide a first type of explanatory information 118 associated with a target model 112. For example, the processor 402 can receive the tuning data 408 from a repository or another computer system on which the explanatory model 116 was tuned. As another example, the processor 402 can execute the tuning process 128 for the explanatory model 116. As part of the tuning process 128, the processor 402 can generate the tuning data 408.

In some examples, the tuning data 408 can include a mapping 412. The mapping 412 can include relationships between (i) inputs 410 to the target model 112 and (ii) corresponding outputs 114 from the target model 112. The target model 112 can produce each output 114 based on an input 410. The inputs 410 may be synthetic data samples 108 generated by the processor 402 or another computer system.

In block 504, the processor 402 stores the tuning data 408 in one or more datastores 414. Although shown as separate components in FIG. 4, in some examples the one or more datastores 414 can include the memory 404.

In block 506, the processor 402 receives a request 416 for a second type of explanatory information 124 associated with the target model 112. The processor 402 can receive the request 416 subsequent to storing the tuning data 408 in the datastore 414. The request 416 may be from a user 302 or another originator, such as a piece of software. The request 416 can include any suitable information, such as a target output 418 from the target model 112. The second type of explanatory information 124 can be different from the first type of explanatory information 118.

In block 508, the processor 402 determines whether any outputs 114 in the mapping 412 match the target output 418. The processor 402 can make this determination in response to receiving the request 416. To make this determination, the processor 402 may generate similarity scores 310 representing the similarity between some or all of the outputs 114 (in the mapping 412) and the target output 418. If an output 114 has a similarity score 310 that is higher (or lower) than a predefined threshold, it may suggest that the output 114 is of sufficient similarity to the target output 418, and thus matches the target output 418.

In block 510, the processor 402, in response to determining that a particular output in the mapping 412 matches the target output 418, determines a particular input in the mapping 412 that corresponds to the particular output. For example, the processor 402 may determine that a particular output (e.g., yᵢ) in the mapping 412 matches the target output 418. So, the processor 402 can determine a particular input (e.g., xᵢ) that corresponds to the particular output in the mapping 412.

In block 512, the processor 402 provide the particular input as the second type of explanatory information 124. For example, the processor 402 can provide the particular input to the user 302 as a response to the request. In some examples, the response may include the particular input as a first version of the second type of explanatory information 124. The response may additionally or alternatively include a second version of the second type of explanatory information 124, which may be generated by the processor 402 or another computer system executing a second type of explanatory model 126.

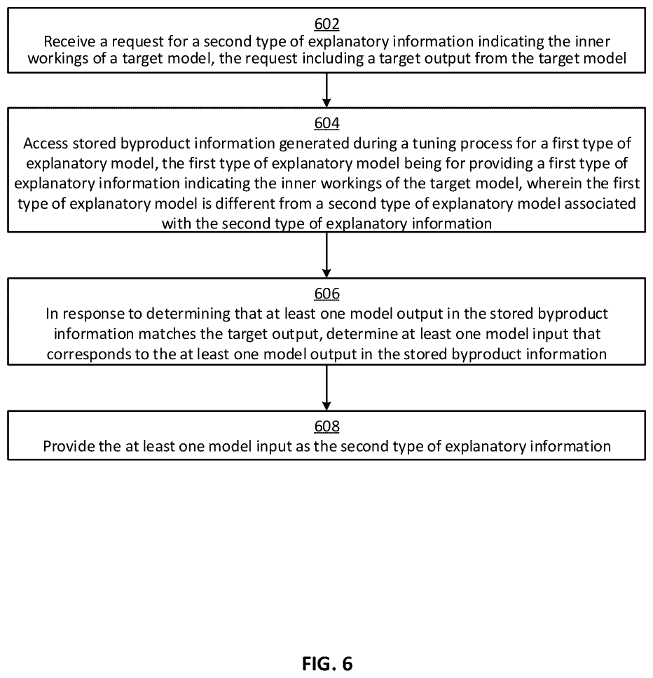

FIG. 6 is a flowchart of another example of a process for reducing computational overhead associated with executing explanatory models by reusing tuning byproducts according to some aspects of the present disclosure. Other examples may involve more operations, fewer operations, different operations, or a different order of operations than is shown in FIG. 6. The operations of FIG. 6 are described below with reference to the components of FIGS. 1-4.

In block 602, the processor 402 receives a request 416 for a second type of explanatory information 124 indicating the inner workings of a target model 112. The request 416 can include a target output 418 from the target model 112. The request 416 can be transmitted by a user 302 or another originator, such as a software application on the computer system 100 or another computer system.

In block 604, the processor 402 accesses stored byproduct information 202 generated during a tuning process 128 for a first type of explanatory model 116. The first type of explanatory model 116 can be for providing a first type of explanatory information 118 indicating the inner workings of the target model 112. The first type of explanatory model 116 can be different from a second type of explanatory model 126 associated with the second type of explanatory information 124. The stored byproduct information 202 can be stored in memory 404 or any other suitable datastore 414, which may be internal to the computer system 100 or external to the computer system 100 (and accessible to the computer system 100 via one or more networks, such as the Internet).

In block 606, the processor 402, in response to determining that at least one model output in the stored byproduct information 202 matches the target output 418, determines at least one model input that corresponds to the at least one model output in the stored byproduct information 202. For example, the processor 402 may determine that three model outputs (e.g., y₁, y₂, and yₙ) in the mapping 412 match the target output 418. So, the processor 402 can determine three model inputs (e.g., x′₁, x′₂, and x′ₙ) that correspond in the mapping 412 to the three model outputs. Alternatively, the processor 402 may determine that just one model output (e.g., yₙ) in the mapping 412 matches the target output 418. So, the processor 402 can determine one or more model inputs (e.g., x′ₙ) that correspond in the mapping 412 to the model output.

In block 608, the processor 402 provides the at least one model input as the second type of explanatory information 124. For example, the processor 402 can provide the at least one model input to the user 302 as a response to the request. In some examples, the response may include the at least one model input as a first version of the second type of explanatory information 124. The response may additionally or alternatively include a second version of the second type of explanatory information 124, which may be generated by the processor 402 or another computer system executing a second type of explanatory model 126.

In some aspects, tuning byproducts can be reused in accordance with one or more of the following examples. As used below, any references to a series of examples is to be understood as a reference to each of those examples disjunctively (e.g., “Examples 1-4” is to be understood as “Examples 1, 2, 3, or 4”).

Example #1: A method involving obtaining, by one or more processors, tuning data used in a tuning process for configuring an explanatory model to provide a first type of explanatory information associated with a target model, the tuning data including a mapping of inputs to the target model and corresponding outputs from the target model; storing, by the one or more processors, the tuning data in a datastore; subsequent to storing the tuning data in the datastore, receiving, by the one or more processors, a request for a second type of explanatory information associated with the target model, the request including a target output from the target model; and in response to receiving the request: determining, by the one or more processors, whether any outputs in the mapping match the target output; in response to determining that a particular output in the mapping matches the target output, determining, by the one or more processors, a particular input in the mapping that corresponds to the particular output; and providing, by the one or more processors, the particular input as the second type of explanatory information.

Example #2: The method of Example #1, wherein the explanatory model is a first type of explanatory model, and the second type of explanatory information is associated with a second type of explanatory model.

Example #3: The method of any of Examples #1-2, wherein the response to the request is determined without executing the second type of explanatory model.

Example #4: The method of any of Examples #1-3, wherein the particular input is a first version of the second type of explanatory information, and further comprising: determining a second version of the second type of explanatory information by executing the second type of explanatory model; and providing the second version of the second type of explanatory information.

Example #5: The method of any of Examples #1-4, wherein the first type of explanatory model is a saliency model, the first type of explanatory information includes saliency values, the second type of explanatory model is a counterfactual explainer model, and the second type of explanatory information is counterfactual information.

Example #6: The method of any of Examples #1-5, further comprising: determining that at least two outputs in the mapping match the target output; determining at least two inputs that correspond in the mapping to the at least two outputs; and providing the at least two inputs as the second type of explanatory information.

Example #7: The method of any of Example #6, further comprising determining similarity scores corresponding to the at least two outputs, each similarity score indicating a level of similarity between a respective output and the target output; determining that the at least two outputs in the mapping match the target output based on the similarity scores; and generating a graphical visualization that indicates the at least two inputs, the at least two outputs, and the similarity scores.

Example #8: The method of any of Examples #1-7, wherein the inputs comprise synthetic data samples for use in tuning the explanatory model, and further comprising generating the inputs based on background data and input data.

Example #9: A non-transitory computer-readable medium comprising program code that is executable by one or more processors for causing the one or more processors to: obtain tuning data used in a tuning process for configuring an explanatory model to provide a first type of explanatory information associated with a target model, the tuning data including a mapping of inputs to the target model and corresponding outputs from the target model; store the tuning data in a datastore; subsequent to storing the tuning data in the datastore, receive a request for a second type of explanatory information associated with the target model, the request including a target output from the target model; and in response to receiving the request: determine whether any outputs in the mapping match the target output; in response to determining that a particular output in the mapping matches the target output, determine a particular input in the mapping that corresponds to the particular output; and provide the particular input as the second type of explanatory information.

Example #10: The non-transitory computer-readable medium of Example #9, wherein the explanatory model is a first type of explanatory model, and the second type of explanatory information is associated with a second type of explanatory model.

Example #11: The non-transitory computer-readable medium of any of Examples #9-10, wherein the response to the request is determined without executing the second type of explanatory model.

Example #12: The non-transitory computer-readable medium of any of Examples #9-11, wherein the particular input is a first version of the second type of explanatory information, and further comprising program code that is executable by the one or more processors for causing the one or more processors to: determine a second version of the second type of explanatory information by executing the second type of explanatory model; and provide the second version of the second type of explanatory information.

Example #13: The non-transitory computer-readable medium of any of Examples #9-12, wherein the first type of explanatory model is a saliency model, the first type of explanatory information includes saliency values, the second type of explanatory model is a counterfactual explainer model, and the second type of explanatory information is counterfactual information.

Example #14: The non-transitory computer-readable medium of any of Examples #9-13, further comprising program code that is executable by the one or more processors for causing the one or more processors to: determine that at least two outputs in the mapping match the target output; determine at least two inputs that correspond in the mapping to the at least two outputs; and provide the at least two inputs as the second type of explanatory information.

Example #15: The non-transitory computer-readable medium of Example #14, further comprising program code that is executable by the one or more processors for causing the one or more processors to: determine similarity scores corresponding to the at least two outputs, each similarity score indicating a level of similarity between a respective output and the target output; determine that the at least two outputs in the mapping match the target output based on the similarity scores; and generate a graphical visualization that indicates the at least two inputs, the at least two outputs, and the similarity scores.

Example #16: The non-transitory computer-readable medium of any of Examples #9-15, wherein the inputs comprise synthetic data samples for use in tuning the explanatory model, and further comprising program code that is executable by the one or more processors for causing the one or more processors to: generate the inputs based on background data and input data.

Example #17: A system comprising: one or more processors; and one or more memories including instructions that are executable by the one or more processors for causing the one or more processors to: obtain tuning data used in a tuning process for configuring an explanatory model to provide a first type of explanatory information associated with a target model, the tuning data including a mapping of inputs to the target model and corresponding outputs from the target model; store the tuning data in a datastore; subsequent to storing the tuning data in the datastore, receive a request for a second type of explanatory information associated with the target model, the request including a target output from the target model; and in response to receiving the request: determine whether any outputs in the mapping match the target output; in response to determining that a particular output in the mapping matches the target output, determine a particular input in the mapping that corresponds to the particular output; and provide the particular input as the second type of explanatory information.

Example #18: The system of Example #17, wherein the explanatory model is a first type of explanatory model, and the second type of explanatory information is associated with a second type of explanatory model.

Example #19: The system of any of Examples #17-18, wherein the response to the request is determined without executing the second type of explanatory model.

Example #20: The system of any of Examples #17-18, wherein the particular input is a first version of the second type of explanatory information, and wherein the one or more memories further include instructions that are executable by the one or more processors for causing the one or more processors to: determine a second version of the second type of explanatory information by executing the second type of explanatory model; and provide the second version of the second type of explanatory information as the second type of explanatory information.

Example #21: A method comprising: receiving, by one or more processors, a request for a second type of explanatory information indicating the inner workings of a target model, the request including a target output from the target model; accessing, by the one or more processors, stored byproduct information generated during a tuning process for a first type of explanatory model, the first type of explanatory model being for providing a first type of explanatory information indicating the inner workings of the target model, wherein the first type of explanatory model is different from a second type of explanatory model associated with the second type of explanatory information; in response to determining that at least one model output in the stored byproduct information matches the target output, determining, by the one or more processors, at least one model input that corresponds to the model output in the stored byproduct information; and providing, by the one or more processors, the at least one model input as the second type of explanatory information.

Example #22: The method of Example #21, wherein providing the at least one model input as the second type of explanatory information involves: providing the at least one model input in a response to the request.

Example #23: The method of any of Examples #21-22, wherein the response is determined without executing the second type of explanatory model.

Example #24: The method of any of Examples #21-23, wherein the at least one model input is a first version of the second type of explanatory information, and further comprising: determining a second version of the second type of explanatory information by executing the second type of explanatory model; and providing the second version of the second type of explanatory information in the response to the request.

Example #25: The method of any of Examples #21-24, wherein the first type of explanatory model is a saliency model, the first type of explanatory information includes saliency values, the second type of explanatory model is a counterfactual explainer model, and the second type of explanatory information is counterfactual information.

Example #26: The method of any of Examples #21-25, further comprising: determining that at least two model outputs in the stored byproduct information match the target output; determining at least two model inputs that correspond in the stored byproduct information to the at least two model outputs; and providing the at least two model inputs as the second type of explanatory information.

Example #27: The method of Example #26, further comprising: determining similarity scores corresponding to the at least two model outputs, each similarity score indicating a level of similarity between a respective model output and the target output; determining that the at least two model outputs in the stored byproduct information match the target output based on the similarity scores; and generating a graphical visualization that indicates the at least two model inputs, the at least two model outputs, or the similarity scores.

Example #28: The method of any of Examples #21-27, wherein the stored byproduct information comprises synthetic data samples generated during the tuning process for use in tuning the first type of explanatory model, and further comprising generating the synthetic data samples based on background data and input data.

Example #29: A non-transitory computer-readable medium comprising program code that is executable by one or more processors for causing the one or more processors to: receive a request for a second type of explanatory information indicating the inner workings of a target model, the request including a target output from the target model; access stored byproduct information generated during a tuning process for a first type of explanatory model, the first type of explanatory model being for providing a first type of explanatory information indicating the inner workings of the target model, wherein the first type of explanatory model is different from a second type of explanatory model associated with the second type of explanatory information; in response to determining that at least one model output in the stored byproduct information matches the target output, determine at least one model input that corresponds to the model output in the stored byproduct information; and provide the at least one model input as the second type of explanatory information.

Example #30: The non-transitory computer-readable medium of Example #29, wherein providing the at least one model input as the second type of explanatory information involves: providing the at least one model input in a response to the request.

Example #31: The non-transitory computer-readable medium of any of Examples #29-30, wherein the response is determined without executing the second type of explanatory model.

Example #32: The non-transitory computer-readable medium of any of Examples #29-31, wherein the at least one model input is a first version of the second type of explanatory information, and further comprising program code that is executable by the one or more processors for causing the one or more processors to: determine a second version of the second type of explanatory information by executing the second type of explanatory model; and provide the second version of the second type of explanatory information in the response to the request.

Example #33: The non-transitory computer-readable medium of any of Examples #29-32, wherein the first type of explanatory model is a saliency model, the first type of explanatory information includes saliency values, the second type of explanatory model is a counterfactual explainer model, and the second type of explanatory information is counterfactual information.

Example #34: The non-transitory computer-readable medium of any of Examples #29-33, further comprising program code that is executable by the one or more processors for causing the one or more processors to: determine that at least two model outputs in the stored byproduct information match the target output; determine at least two model inputs that correspond in the stored byproduct information to the at least two model outputs; and provide the at least two model inputs as the second type of explanatory information.

Example #35: The non-transitory computer-readable medium of Example #34, further comprising program code that is executable by the one or more processors for causing the one or more processors to: determine similarity scores corresponding to the at least two model outputs, each similarity score indicating a level of similarity between a respective model output and the target output; determine that the at least two model outputs in the stored byproduct information match the target output based on the similarity scores; and generate a graphical visualization that indicates the at least two model inputs and the similarity scores.

Example #36: The non-transitory computer-readable medium of any of Examples #29-35, wherein the stored byproduct information comprises synthetic data samples associated with tuning the first type of explanatory model, and further comprising program code that is executable by the one or more processors for causing the one or more processors to: generate the synthetic data samples based on background data and input data.

Example #37: A system comprising: means for obtaining tuning data used in a tuning process for configuring an explanatory model to provide a first type of explanatory information associated with a target model, the tuning data including a mapping of inputs to the target model and corresponding outputs from the target model; means for storing the tuning data in a datastore; means for, subsequent to storing the tuning data in the datastore, receiving a request for a second type of explanatory information associated with the target model, the request including a target output from the target model; and means for, in response to receiving the request: determining whether any outputs in the mapping match the target output; in response to determining that a particular output in the mapping matches the target output, determining a particular input in the mapping that corresponds to the particular output; and providing the particular input as the second type of explanatory information.

The above description of certain examples, including illustrated examples, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

1. A method comprising:
obtaining, by one or more processors, tuning data used in a tuning process for configuring an explanatory model to provide a first type of explanatory information associated with a target model, the tuning data including a mapping of inputs to the target model and corresponding outputs from the target model;
storing, by the one or more processors, the tuning data in a datastore;
subsequent to storing the tuning data in the datastore, receiving, by the one or more processors, a request for a second type of explanatory information associated with the target model, the request including a target output from the target model; and
in response to receiving the request:
determining, by the one or more processors, whether any outputs in the mapping match the target output;
in response to determining that a particular output in the mapping matches the target output, determining, by the one or more processors, a particular input in the mapping that corresponds to the particular output; and
providing, by the one or more processors, the particular input as the second type of explanatory information.

2. The method of claim 1, wherein the explanatory model is a first type of explanatory model, and the second type of explanatory information is associated with a second type of explanatory model.

3. The method of claim 2, wherein the response to the request is determined without executing the second type of explanatory model.

4. The method of claim 2, wherein the particular input is a first version of the second type of explanatory information, and further comprising:
determining a second version of the second type of explanatory information by executing the second type of explanatory model; and
providing the second version of the second type of explanatory information.

5. The method of claim 2, wherein the first type of explanatory model is a saliency model, the first type of explanatory information includes saliency values, the second type of explanatory model is a counterfactual explainer model, and the second type of explanatory information is counterfactual information.

6. The method of claim 1, further comprising:
determining that at least two outputs in the mapping match the target output;
determining at least two inputs that correspond in the mapping to the at least two outputs; and
providing the at least two inputs as the second type of explanatory information.

7. The method of claim 6, further comprising:
determining similarity scores corresponding to the at least two outputs, each similarity score indicating a level of similarity between a respective output and the target output;
determining that the at least two outputs in the mapping match the target output based on the similarity scores; and
generating a graphical visualization that indicates the at least two inputs, the at least two outputs, and the similarity scores.

8. The method of claim 1, wherein the inputs comprise synthetic data samples for use in tuning the explanatory model, and further comprising generating the inputs based on background data and input data.

9. A non-transitory computer-readable medium comprising program code that is executable by one or more processors for causing the one or more processors to:
obtain tuning data used in a tuning process for configuring an explanatory model to provide a first type of explanatory information associated with a target model, the tuning data including a mapping of inputs to the target model and corresponding outputs from the target model;
store the tuning data in a datastore;
subsequent to storing the tuning data in the datastore, receive a request for a second type of explanatory information associated with the target model, the request including a target output from the target model; and
in response to receiving the request:
determine whether any outputs in the mapping match the target output;
in response to determining that a particular output in the mapping matches the target output, determine a particular input in the mapping that corresponds to the particular output; and
provide the particular input as the second type of explanatory information.

10. The non-transitory computer-readable medium of claim 9, wherein the explanatory model is a first type of explanatory model, and the second type of explanatory information is associated with a second type of explanatory model.

11. The non-transitory computer-readable medium of claim 10, wherein the response to the request is determined without executing the second type of explanatory model.

12. The non-transitory computer-readable medium of claim 10, wherein the particular input is a first version of the second type of explanatory information, and further comprising program code that is executable by the one or more processors for causing the one or more processors to:
determine a second version of the second type of explanatory information by executing the second type of explanatory model; and
provide the second version of the second type of explanatory information.

13. The non-transitory computer-readable medium of claim 10, wherein the first type of explanatory model is a saliency model, the first type of explanatory information includes saliency values, the second type of explanatory model is a counterfactual explainer model, and the second type of explanatory information is counterfactual information.

14. The non-transitory computer-readable medium of claim 9, further comprising program code that is executable by the one or more processors for causing the one or more processors to:
determine that at least two outputs in the mapping match the target output;
determine at least two inputs that correspond in the mapping to the at least two outputs; and
provide the at least two inputs as the second type of explanatory information.

15. The non-transitory computer-readable medium of claim 14, further comprising program code that is executable by the one or more processors for causing the one or more processors to:
determine similarity scores corresponding to the at least two outputs, each similarity score indicating a level of similarity between a respective output and the target output;
determine that the at least two outputs in the mapping match the target output based on the similarity scores; and
generate a graphical visualization that indicates the at least two inputs, the at least two outputs, and the similarity scores.

16. The non-transitory computer-readable medium of claim 9, wherein the inputs comprise synthetic data samples for use in tuning the explanatory model, and further comprising program code that is executable by the one or more processors for causing the one or more processors to:
generate the inputs based on background data and input data.

17. A system comprising:
one or more processors; and
one or more memories including instructions that are executable by the one or more processors for causing the one or more processors to:
obtain tuning data used in a tuning process for configuring an explanatory model to provide a first type of explanatory information associated with a target model, the tuning data including a mapping of inputs to the target model and corresponding outputs from the target model;
store the tuning data in a datastore;
subsequent to storing the tuning data in the datastore, receive a request for a second type of explanatory information associated with the target model, the request including a target output from the target model; and
in response to receiving the request:
determine whether any outputs in the mapping match the target output;
in response to determining that a particular output in the mapping matches the target output, determine a particular input in the mapping that corresponds to the particular output; and
provide the particular input as the second type of explanatory information.

18. The system of claim 17, wherein the explanatory model is a first type of explanatory model, and the second type of explanatory information is associated with a second type of explanatory model.

19. The system of claim 18, wherein the response to the request is determined without executing the second type of explanatory model.

20. The system of claim 18, wherein the particular input is a first version of the second type of explanatory information, and wherein the one or more memories further include instructions that are executable by the one or more processors for causing the one or more processors to:
determine a second version of the second type of explanatory information by executing the second type of explanatory model; and
provide the second version of the second type of explanatory information as the second type of explanatory information.
